(19) United States
(12) Patent Application Publication
(10) Pub. No.: US 2002/0030104 A1
(43) Pub. Date: Mar. 14, 2002

(54) Code reading apparatus, recording medium, electronic device, data transmission/reception system and data transmission/ reception method

(75) Inventors: Akira Matsui, Hachioji-shi (JP); Hiroyuki Fukuda, Hachioji-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/947,280

(22) Filed: Sep. 6, 2001

(30) Foreign Application Priority Data
Sep. 12, 2000 (JP) 2000-277049

(51) Int. Cl. G06K 7/10; G06K 7/14

(52) U.S. Cl. 235/454

(57) ABSTRACT

A two-dimensional dot code recorded on a recording medium that may be a sheet of paper includes a transmission data to be transmitted from a code reading apparatus that restores the data represented by the dot code to an electronic device that may be a video recorder or a mobile telephone set and a transmission control data necessary for transmitting the transmission data from the code reading apparatus to the other electronic device. The code reading apparatus comprises an external I/F section for transmitting the transmission data to the other electronic device according to the transmission control data.

### CROSS-REFERENCE TO RELATED APPLICATIONS

This application is based upon and claims the benefit of priority from the prior Japanese Patent Application No. 2000-277049, filed Sep. 12, 2000, the entire contents of which are incorporated herein by reference.

### BACKGROUND OF THE INVENTION

1. Field of the Invention

This invention relates to a code reading apparatus adapted to read optically readable codes representing sounds, images, text data and/or other data that computers can deal with and transmit them to external electronic devices and also a recording medium storing such optically readable codes and an electronic device capable of receiving externally input data as well as a data transmission/reception system comprising such devices as listed above and a data transmission/reception method to be used for such a data transmission/reception system.

2. Description of the Related Art

Advanced video recording reservation systems of video recorders are typical systems that are adapted to read a bar code representing the information on the use of a device by a dedicated scanner and make arrangements for any additional use of the device by using the information.

Normally, when making reservations for the use of a video recorder by a video recording reservation system, the system requires a cumbersome operation of using the buttons and the remote control of the video recorder main body in order to directly enter the time of starting the recording, the time of ending the recording, the selected TV transmission channel and other pieces of information necessary for the reservation. Systems using bar codes and a scanner have been proposed as means for dissolving this problem. With a system using bar codes and a scanner, each of the bar codes contains information on the time of starting the recording, the time of ending the recording, the selected channel and other pieces of information necessary for the reservation and a dedicated scanner is used to read the bar code and transmits it to the video recorder for the reservation. In other words, the user simply has to scan the code by the scanner and is not required to do any cumbersome operation for the reservation.

Microwave cookers adapted to utilize bar codes and a scanner for an advanced reservation system are also known. Then, a bar code represents information including the duration of heating of the microwave cooker and/or that of the oven, when it is used as oven along with the heating temperature. The bar code contains optimal values for each cooking recipe so that optimal procedures can be selected for the selected cooking session simply by scanning the corresponding bar code.

Thus, with a system using bar codes and a scanner, each bar code contains information necessary for the use of the device and the user can operate the device in a desired manner simply by scanning the corresponding bar code. Jpn. Pat. Appln. KOKAI Publications Nos. 10-126480, 9-152924 and 10-232766 describe such systems adapted to a mobile telephone set, a set top box and a cash register (commodity sales information processing device) respectively.

Such systems are advantageous in that multi-functional electronic device that normally involves complicated operation procedures can be operated in a simple manner.

However, with the above identified prior art, the mode of connecting the scanner and the device main body is fixed and the scanner is dedicated to the device so that the scanner cannot be applied to devices of different types. In other words, each device needs to be provided with a dedicated scanner to make it difficult to reduce the cost of the device.

### BRIEF SUMMARY OF THE INVENTION

In view of the above identified problems, it is therefore an object of the present invention to provide a code reading apparatus for optically reading an optically readable code from a recording medium storing the code that represents data and can be optically read by a manual scanning operation, for the use of which the user does not need to know in advance the communication procedures to be followed when it is connected to an external device and which can be connected to a number of external devices simply by altering the communicating procedure stored in the code for communicating with an external device.

Another object of the present invention is to provide a recording medium to be used with such a code reading apparatus, an electronic device to which data can be input from such a code reading apparatus, a data transmission/reception system comprising such devices as listed above and a data transmission/reception method to be used for such a data transmission/reception system.

According to a first aspect of the present invention, there is provided a code reading apparatus comprising:

means for optically reading a code representing a data and for restoring the data, the code being recorded on a recording medium and being optically readable by manual scanning; and

data transmitting means for transmitting transmission data to some other electronic device according to transmission control data, when the data includes the transmission data to be transmitted from the code reading apparatus to the other electronic device and utilized by the other electronic device and the transmission control data required for transmitting the transmission data from the code reading apparatus to the other electronic device.

According to a second aspect of the present invention, there is provided a recording medium storing a recorded code representing data and adapted to be optically read by manual scanning, the data comprising:

transmission data to be transmitted from a code reading apparatus adapted to read the code to some other electronic device and utilized by the other electric device; and

transmission control data necessary for transmitting the transmission data from the code reading apparatus to the other electronic device.

According to a third aspect of the present invention, there is provided an electronic device adapted to receive data transmitted from a code reading apparatus which optically reads a code representing the data and recorded on a recording medium by manual scanning and restores the data and to utilize the data, the electronic device comprising:

data receiving means for receiving transmission data transmitted from the code reading apparatus according to transmission control data, when the data restored by the code reading apparatus includes the transmission data to be transmitted from the code reading apparatus to the electronic device and utilized by the electronic device and the transmission control data required for transmitting the transmission data from the code reading apparatus to the electronic device; and

data utilizing means for utilizing the transmission data received by the data receiving means.

According to a fourth aspect of the present invention, there is provided a data transmission/reception system comprising:

a code reading apparatus adapted to optically read a code representing a data and recorded on a recording medium optically readable by manual scanning and restore the data; and

an electronic device adapted to receive and utilize the data transmitted from the code reading apparatus, wherein

the code reading apparatus includes data transmitting means for transmitting transmission data to the electronic device according to transmission control data, when the data includes the transmission data to be transmitted from the code reading apparatus to the electronic device and utilized by the electronic device and the transmission control data required for transmitting the transmission data from the code reading apparatus to the electronic device, and

the electronic device includes data receiving means for receiving the transmission data transmitted from the code reading apparatus according to the transmission control data.

According to a fifth aspect of the present invention, there is provided a data transmission/reception method to be used by a code reading apparatus adapted to optically read a code representing a data and recorded on a recording medium optically readable by manual scanning and restore the data and an electronic device adapted to receive and utilize the data transmitted from the code reading apparatus, comprising:

transmitting transmission data to the other electronic device from the code reading apparatus according to transmission control data, when the data includes the transmission data to be transmitted from the code reading apparatus to the electronic device and utilized by the other electronic device and the transmission control data required for transmitting the transmission data from the code reading apparatus to the other electronic device; and

receiving at the electronic device the transmission data transmitted from the code reading apparatus according to the transmission control data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below.

FIG. 1 is a schematic illustration of a first embodiment of code reading apparatus of the invention, showing how it is used;

FIG. 2 is a schematic illustration of a dot code as an optically readable code, showing its physical format;

FIG. 3 is a schematic block diagram of a known code reading apparatus;

FIG. 4 is a schematic illustration of the logical structure of a data that can be read from a dot code;

FIG. 5 is a schematic illustration of the logical structure of a data classified as communication data;

FIG. 6 is a flow chart of the operation of a code reading apparatus;

FIG. 7 is a schematic illustration of the logical structure of the data section of a data that can be read from a dot code to be used for mobile telephone sets;

FIG. 8 is a schematic illustration of the operation to be performed for connecting a second embodiment of code reading apparatus of the invention and a mobile telephone set and transmitting data from the former to the latter;

FIG. 9 shows a flow chart of the operation of the second embodiment of code reading apparatus of the invention and that of the corresponding operation of an external device;

FIG. 10 is a schematic illustration of the logical structure of the data section of a data that can be read from a dot code by the second embodiment of code reading apparatus;

FIG. 11 shows a flow chart of the operation of a third embodiment of code reading apparatus of the invention and that of the corresponding operation of an external device;

FIG. 12 is a schematic illustration of the logical structure of the data section of a data that can be read from a dot code by a fourth embodiment of code reading apparatus of the invention;

FIG. 13 is a flow chart of the operation of the fourth embodiment of code reading apparatus of the invention.

FIG. 14 is a schematic illustration of the logical structure of the data section of another data that can be read from a dot code by the fourth embodiment of code reading apparatus of the invention;

FIG. 15 is a schematic illustration of the logical structure of the data section of a data that can be read from a dot code by a fifth embodiment of code reading apparatus of the invention;

FIG. 16 shows a flow chart of the operation of the fifth embodiment of code reading apparatus of the invention and that of the corresponding operation of an external device;

FIG. 17 is a table showing external devices and the formats to be respectively used by them;

FIG. 18 is a schematic illustration of the operation of connecting a sixth embodiment of code reading apparatus of the invention to a mobile telephone set, a PDA and a silicon audio set and transmitting data to them;

FIG. 19 is a flow chart of the operation of the sixth embodiment of code reading apparatus according to the invention; and is a schematic illustration of the logical structure of the data section of a data that can be read from a dot code by the sixth embodiment of code reading apparatus of the invention.

### DETAILED DESCRIPTION OF THE INVENTION

Now, the invention will be described in greater detail by referring to the accompanying drawings that illustrate preferred embodiments of the invention.

[1st Embodiment]

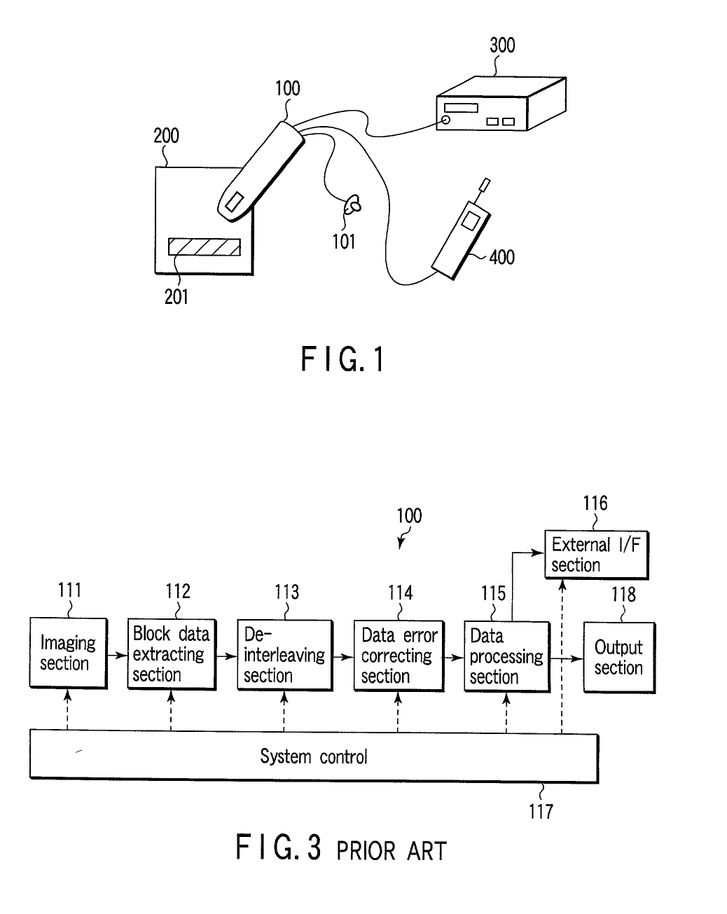

FIG. 1 is a schematic illustration of a first embodiment of code reading apparatus of the invention, which is denoted by reference symbol 100, showing how it is used. More specifically, the user (operator) can hold the code reading apparatus 100 main body and scan a dot code 201 as a two-dimensional code recorded on the surface of a sheet-shaped recording medium 200, which is a sheet of paper, by the code reading apparatus 100. The code reading apparatus 100 includes an earphone 101 so that the code reading apparatus 100 may output the original sound information restored by the processing operation of the code reading apparatus 100 through the earphone 101, if the dot code 201 read by the code reading apparatus 100 includes sound information. The code reading apparatus 100 further includes an external I/F unit to be used for connecting the code reading apparatus 100 to one or more than one external devices such as a video recorder 300 and a mobile telephone set 400 and exchanging data with them.

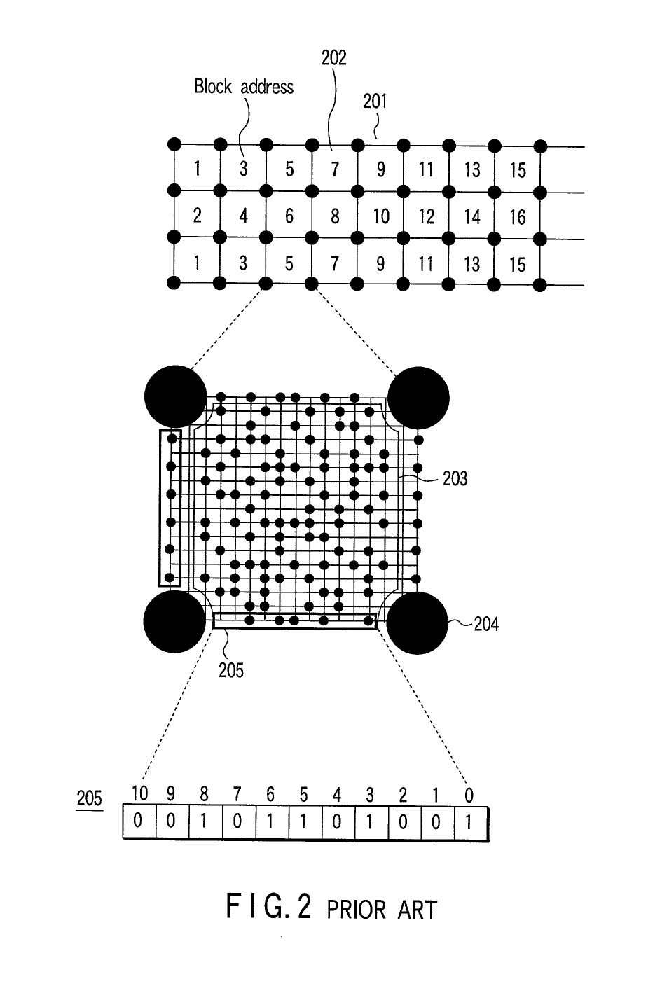

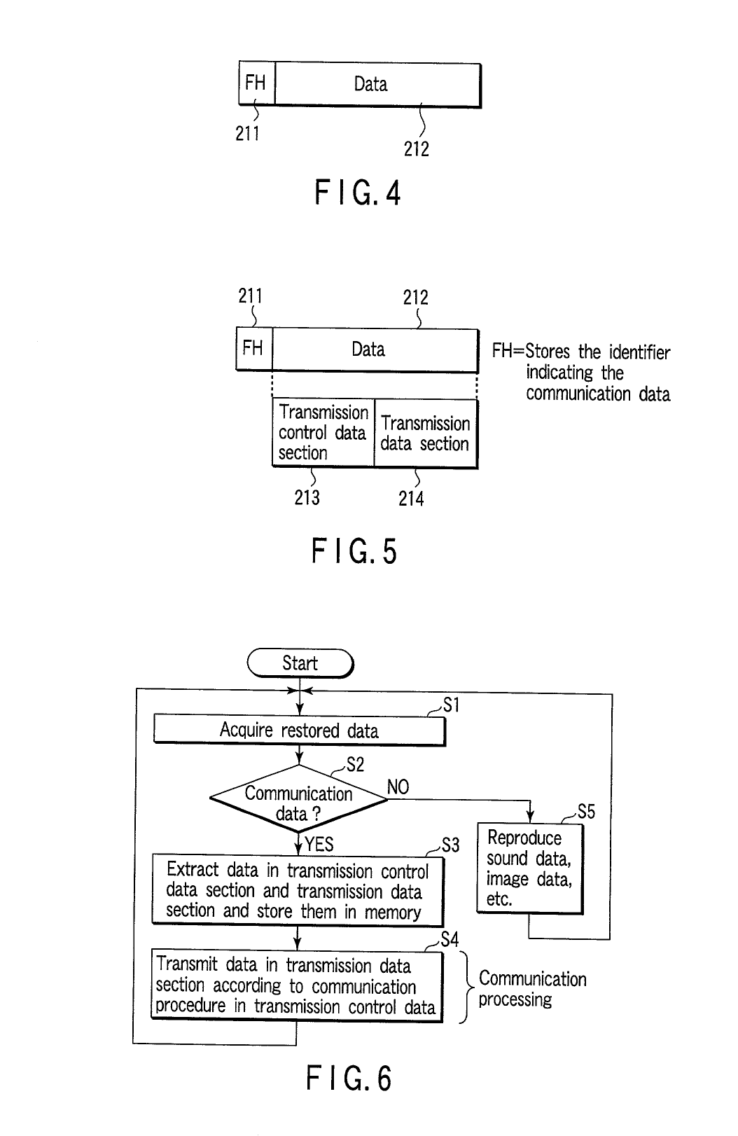

The dot code 201 may be such as disclosed in U.S. Pat. No. 5,896,403, U.S.P. Re. 36,589 or U.S. Pat. No. 6,134,695. The dot code 201 has a format as shown in FIG. 2. Referring to FIG. 2, the dot code 201 is formed by arranging a plurality of blocks 202. The blocks 202 include a data dot pattern section 203, markers 204 and a block address pattern section 205. The data dot pattern section 203 comprises a plurality of dots arranged so as to represents a data. The markers 204 show a pattern that cannot be find in the data dot pattern section 203 and are arranged to show a predetermined positional relationship relative to the data dot pattern section 203. Then, the block address pattern section 205 is arranged to show a predetermined positional relationship relative to the makers 204 and indicates the address of the block.

FIG. 3 is a schematic block diagram of the code reading apparatus 100, which may also be such as disclosed in U.S. Pat. No. 5,896,403, U.S.P. Re. 36,589 or U.S. Pat. No. 6,134,695. More specifically, the code reading apparatus 100 comprises an image pickup section 111, a block data extracting section 112, a de-interleaving section 113, a data error correcting section 114, a data processing section 115, an external I/F section 116, a system control section 117 and an output section 118. The image pickup section 111 is used to pick up an image of the dot code 201. The block extracting section 112 identifies the image data fed from the image pickup section 111 as dot code 201 and extract the data of each of the blocks that constitutes the dot code 201. The de-interleaving section 113 rearranges the columns of data obtained by the block data extracting section 112. The data error correcting section 114 corrects the reading errors and the data errors in the data fed from the de-interleaving section 113. The data processing section 115 divides the data whose errors are corrected by the data error correcting section 114 according to its attributes and processes it for expansion and transmission/reception for the external I/F section 116. The external I/F section 116 receives the data to be used for transmission/reception from the data processing section 115 and exchanges data with one or more than one external devices. The system control section 117 comprises a CPU, a ROM storing instructions and data to be used by the CPU and a work memory. It controls the components including the image pickup section 111 through the external I/F section 116 and exchanges data with them. The output section 118 may include the earphone 101.

Now, the operation of reading a dot code 201 of the code reading apparatus 100 having the above described configuration will be described below.

Upon receiving a command for reading the dot code 201 from a read command issuing means (not shown) typically comprising a switch, the system control section 117 causes the image pickup section 111 and the block data extracting section 112 to start an operation of reading the dot code 201. The image pickup section 111 typically comprises an imaging device such as CCD, an LED for illuminating the dot code 201 and a lens for producing an image of the dot code illuminated by the LED on the imaging device. Thus, it picks up an image of the dot code 201. The block data extracting section 112 carries out a processing operation of binarizing the image data of the dot code 201 picked up by the image pickup section 111. Subsequently, it detects the block 202 by referring to the markers 204 of the block 202 of the dot code 201 from the image and extracts the data of the block 202, which is then stored in the memory by referring to the address of the block 202. The operation of reading the dot code 201 proceeds in a manner as described above. The code reading apparatus 101 carries on this operation until the system control section 117 issues a command for ending the reading operation by way of the command issuing means.

The command for starting a reading operation may be an action of depressing a switch and the command for ending the reading operation may be an action of releasing the switch that has been depressed during the reading operation.

After the end of the reading operation, the de-interleaving section 113 rearranges (de-interleaves) the block data stored in the memory by the block data extracting section 112 and outputs the de-interleaved block data to the data error correcting section 114. The data error correcting section 114 performs an error correcting operation on the data sent from the de-interleaving section 113 to corrects the errors produced at the time of reading the dot code 201.

The data processing section 115 finds out the type of the data whose errors are corrected by the data error correcting section 114 by referring to the header information of the restored data and processes the data. Namely, the logical structure of a data that can be read from a dot code 201 is schematically illustrated, and the data comprises a file header section 211 to be used for identifying the type of the restored data and a data section 212. The file header section 211 may describe the type of data (sound data, image data, text data, communication data, etc.) and the compression method of the data stored in the data section 212. Thus, the data processing section 115 finds out the type of the data by referring to the information in the file header section 211.

If the data stored in the data section 212 is other than a communication data to be used for the purpose of communicating with one or more than one external devices, in other words if its is a sound data, an image data, a text data or some other data, the data processing section 115 expands the data and outputs the expanded data to the output section 118. In the case of the code reading apparatus 100 shown in FIG. 1, where the output section 118 includes only the earphone 101 for producing sound data, the data processing section 115 may expand the data and output the expanded data to the output section 118 only when they it is determined to be a sound data.

If, on the other hand, the data is determined to be not a sound data but an image data or a text data, the data processing section 115 does not expand the data and issues a warning telling the operator of the code reading apparatus 100 that the data is of the type that the code reading apparatus 100 cannot deal with. The warning may be a warning sound emitted from the earphone 101 or flashes light emitted from an LED (not shown).

Now, the operation of the data processing section 115 when the data is a communication data as determined from the description in the file header section 211 will be described below.

FIG. 5 is a schematic illustration of the logical structure of a data classified as communication data. Then, the data section 212 includes a transmission control data section 213 and a transmission data section 214. The transmission control data section 213 stores information on the communication procedures to be followed when communicating with one or more than one external devices such as a device recognition procedure required for connecting the code reading apparatus 100 to an external device and the method for controlling the timings of communication signals. The transmission data section 214 stores the data to be transmitted to the external device.

The processing operation of the data processing section 115 when such a data is found will be described by referring to the flow chart of FIG. 6.

Firstly, as the restored data is obtained (and hence the operations including that of picking up an image of the dot code of the image pickup section 111 through that of error correction of the error correcting section 114 are over) (Step S1), the data processing section 115 determines if the data is a communication data to be used for connecting the code reading apparatus 100 to an external device or not by referring to the file header section 211 of the data read from the dot code 201 (Step S2).

If it is determined that the data is a communication data, the data processing section 115 extract the transmission control data section 213 and the transmission data section 214 from the data section 212 and stores them in the memory so as to make them identifiable (Step S3). Subsequently, it starts transmitting the data in the transmission data section 214 by way of the external I/F section 116, according to the communication procedures to be followed when connecting the code reading apparatus 100 to an external device that are stored in the transmission control data section 213, and continues the transmission until all the data are transmitted (Step S4).

If, on the other hand, it is determined that the data is not a communication data but some other data such as a sound data or an image data, the data processing section 115 performs the processing operation of expanding the data as described above and outputs the expanded data to the output section 118 to reproduce the data, which may be a sound data or an image data (Step S5).

The external I/F section 116 for transmitting data to and receiving data from an external device may be adapted to wired communications using an RS-232C, a USB and/or Ethernet and/or radio communications using infrared (IR) rays, FM waves and/or Bluetooth. It may be needless to say that it is assumed here that the external I/F section 116 and the external device are made to match each other for mutual connection in terms of communication rate and other factors including the physical layers thereof.

While the data processing section 115 starts transmitting the transmission data in Step S4 immediately after the extraction of the data in the transmission control data section 213 and the transmission data section 214 in Step S3 in the above description, it may alternatively be so arranged that the transmission in Step S4 is started in response to an action of depressing a switch (not shown) (which may or may not be the switch used for issuing a command for reading data). This arrangement is advantageous from the viewpoint of convenience of the user and reduction of communication errors because the operator can start transmitting data after completing the operation of scanning the dot code 201 and, if an external I/F for wired communications is used, connecting the code reading apparatus 100 to an external device by a cable or, if an external I/F for radio communications is used, selecting the position of the code reading apparatus 100, the distance from the code reading apparatus 100 to the external device and the relative direction of the code reading apparatus 100 and the external device (that can minimize communication errors).

Still alternatively, it may be so arranged that the data of the transmission control data section 213 and that of the transmission data section 214 stored in Step S3 above are held there until a new dot code 201 is read and the data of the transmission control data section 213 and that of the transmission data section 214 stored and held in the memory are transmitted according to the related information contained in the data if a new dot code is not read when the switch (not shown) is depressed. With this arrangement, the data of a dot code 201 can be transmitted to a plurality of devices by scanning the dot code only once.

Now, the operation of the code reading apparatus 100 connected to a mobile telephone set 400 as shown in FIG. 1 will be described in detail.

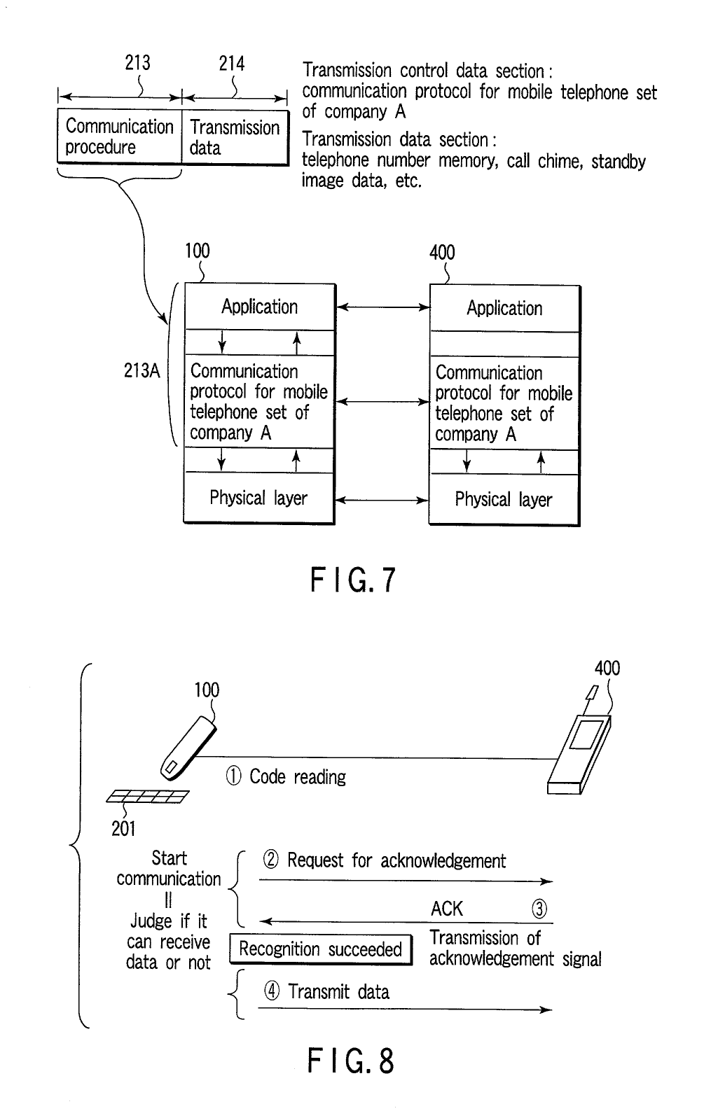

The code reading apparatus 100 and the mobile telephone set 400 are physically connected typically by a cable. FIG. 7 is a schematic illustration of the logical structure of the data section 212 of a data that can be read from a dot code to be used for mobile telephone sets. Referring to FIG. 7, the transmission control data section 213 stores information necessary for connecting the code reading apparatus 100 and the mobile telephone set 400 including the communication protocol corresponding to each of the devices which is shown as communication procedure 213A in a layer above the physical layer in FIG. 7 and application programs to be used with the communication protocol for communications. On the other hand, the transmission data section 214 stores telephone numbers, data on the standby images to be displayed on the screen of the mobile telephone set 400 and data on the call chime to be sounded from the mobile telephone set 400 in order to notify the user of a call.

As the dot code 201 is scanned, the code reading apparatus 100 processes the data in the transmission data section 214 and carries out a communication according to the communication protocol in the transmission control data section 213. For example, the transmission control data section 213 typically stores commands including those for writing a call chime and a standby image to the mobile telephone set 400 and the data processing section 115 of the code reading apparatus 100 can transmit and write the data in the transmission data section 214 to the mobile telephone set 400 by way of the external I/F section 116.

Thus, as described above, with this embodiment of code reading apparatus 100, which the code reading apparatus 100 does not need to know in advance the connection procedures to be followed when it is connected to an external device. Since the data in the transmission data section 214 of a dot code 201 is transmitted by following the connection procedures to be used for connecting an external device stored in the transmission control data section 213 of the dot code 201, the code reading apparatus 100 can be connected to any external device with which it can share a physically common connection I/F only by rewriting the connection procedures in the transmission control section 213.

Additionally, since the code reading apparatus 100 carries out a communication, following the communication procedures stored in the transmission control data section 213 of a dot code 201 once the dot code 201 is scanned, the user can get rid of the trouble of following the cumbersome communication procedures defined for each external device to be connected to the code reading apparatus 100. Therefore, the user is relieved of making errors when following the communication procedures.

Still additionally, if a novel external device is introduced, it can be connected to the code reading apparatus 100 simply by modifying the connection procedures stored in the dot code 100 so as to make them adapted to the device. In other words, the hardware of the code reading apparatus 100 does not require any modification.

[2nd Embodiment]

Now, a second embodiment of the invention will be described below.

With the first embodiment, the data in the transmission data section 214 is transmitted to the external device by following the communication procedures stored in the transmission control data section 213 extracted from the restored data regardless if the code reading apparatus 100 is actually connected to the external device or not. On the other hand, with this second embodiment, the recognition procedures to be used for the external device that is to be connected to the code reading apparatus 100 are stored in the transmission control data section 213 so that the code reading apparatus 100 tries to recognize the external device, following the recognition procedures for the external device, before transmitting the data in the transmission data section 214 and the data in the transmission data section 214 is transmitted only when the recognized external device is determined to be ready for receiving the data.

FIG. 8 is a schematic illustration of the operation to be performed for connecting the second embodiment of code reading apparatus 100 and a mobile telephone set 400 and transmitting data from the former to the latter.

To begin with, the entire operation will be briefly summarized. Firstly, as the code reading apparatus 100 completes the operation of reading the dot code 201, it transmits an acknowledgement request signal to the mobile telephone set 400, notifying the start of a communication. Upon receiving the acknowledgement request signal, the mobile telephone set 400 transmits an acknowledgement signal in response to the request signal. After receiving the acknowledgement signal and confirming that it is connected to the mobile telephone set 400, the code reading apparatus 100 starts transmitting data.

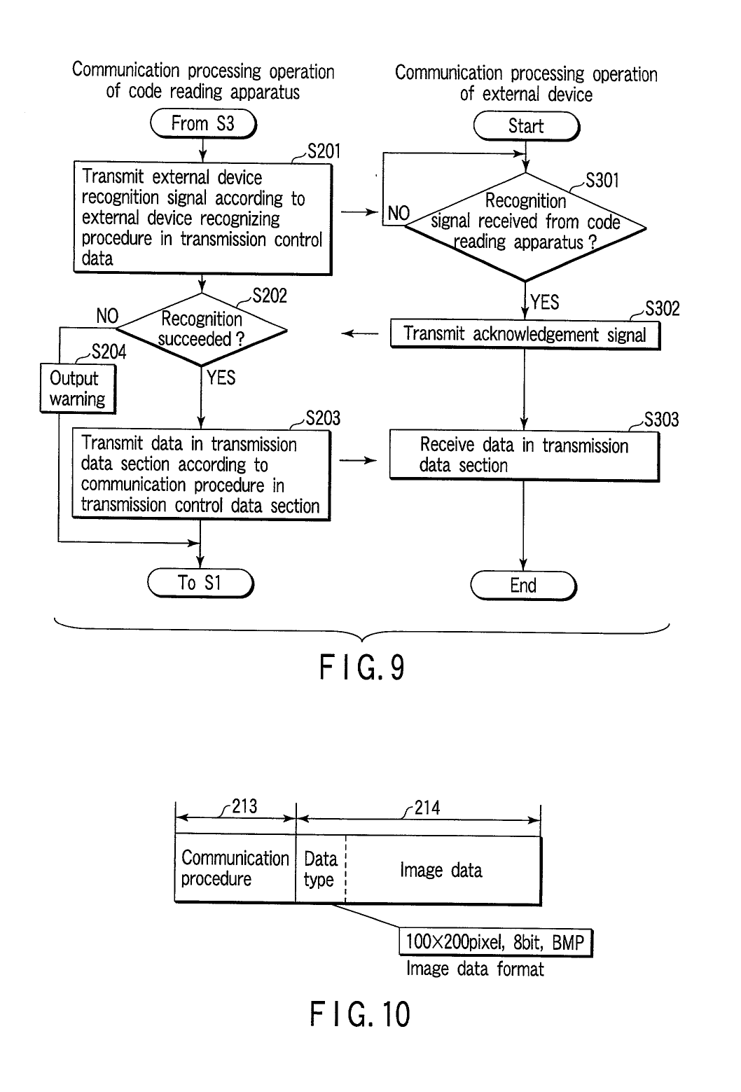

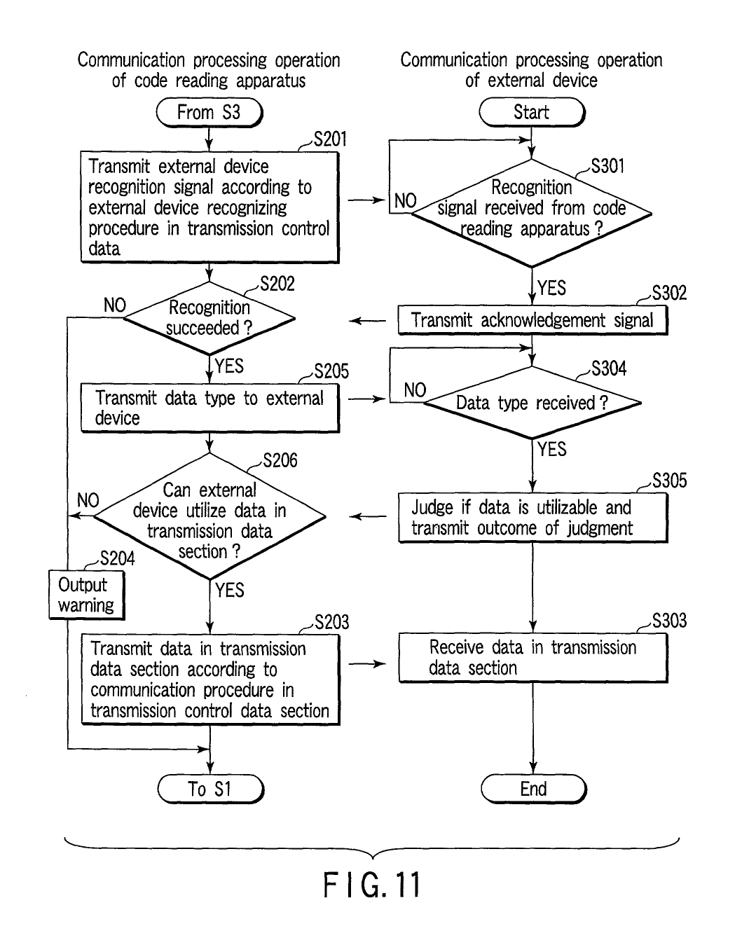

This operation will be described further by referring to FIGS. 9 and 10. As shown in FIG. 10, the transmission control data section 213 of the dot code 201 stores communication procedures to be followed by the code reading apparatus 100 including the one for recognizing an external device and the one for exchanging data with the external device, while the transmission data section 214 of the dot code stores a restored image data. FIG. 9 shows a flow chart of the communication processing operation of the code reading apparatus 100 and that of the corresponding operation of an external device for receiving the data from the code reading apparatus 100. It will be appreciated that the flow chart of the component processing operation corresponds to the operation of Step S4 in FIG. 6. In fact, it is obtained by modifying the operation of Step S4 of FIG. 6. While not shown in the flow chart of FIG. 9, the processing operation of the code reading apparatus 100 from acquiring restored data to extracting data from the transmission control data section 213 and the transmission data section 214 and storing them in the memory and the processing operation to be carried out by the code reading apparatus 100 when the restored data is a sound data or an image data are respectively similar to those from Step S1 through Step S3 and Step S5 in FIG. 6.

Thus, the code reading apparatus 100 transmits a signal for recognizing the external device according to the recognition procedure stored in the transmission control data section 213 (Step S201). For example, the code reading apparatus 100 may repeatedly transmit an acknowledgement request signal at predetermined regular intervals to request an acknowledgement signal from the external device.

Upon receiving a predetermined recognition signal from the code reading apparatus 100 (Step S301), the external device transmits an acknowledgement signal to the code reading apparatus 100, showing that it has correctly received the recognition signal and is ready for receiving data (Step S302).

The code reading apparatus 100 determines if an acknowledgement signal is received in a predetermined format from the external device or not (Step S202). If it is determined that an acknowledgement signal is received in the predetermined format from the external device, the latter is recognized as device capable of receiving restored data. If the external device can receive restored data, the code reading apparatus 100 starts transmitting the data of the transmission data section 214 and continues the transmission until all the data are transmitted (Step S203).

Therefore, the external device continues the reception of data (Step S303).

If, on the other hand, it is determined in Step S202 that the code reading apparatus 100 cannot recognize the external device or does not receive an acknowledgement signal in a predetermined format because the external device is not qualified nor connected to receive restored data, the code reading apparatus 100 issues a warning to the user, telling that the external device is not an electronic device capable of receiving the data to be transmitted and hence cannot adapt itself to the code (Step S204), and terminates the operation without transmitting data.

Thus, the above described second embodiment of code reading apparatus 100 tries to recognize the external device according to the procedures for recognizing an external device stored in the dot code 201, and transmits data only when it recognizes the external device as qualified for connection. In other words, it does not transmit data to the external device only when the latter is adapted to the dot code 201. Therefore, it can effectively avoid a situation where it transmits data to an unqualified external device at the risk of causing operation errors on the part of the latter if it is connected to the external device that is not adapted to the dot code 201.

[3rd Embodiment]

According to a third embodiment of the invention, it is also possible for a code reading apparatus to transmit data to an external device only after recognizing the latter and confirming that the external device is adapted to the data in the transmission data section 214. FIG. 11 is a flow chart of the processing operation of the third embodiment before transmitting data. Referring to FIG. 11, Steps S205, S206, S304 and S305 are used to confirm that the external device is adapted to the data stored in the transmission data section 214 of the dot code 201. Since all the other steps are same as the corresponding steps in the flow chart of FIG. 9, they will not be described any further.

If it is determined in Step S202 that the external device can receive the data of the dot code 201, the code reading apparatus 100 notifies the external device of the data type including the type (image data, sound data, text data, etc.) and the format (compression format, etc.) of the data stored in the transmission data section 214 of the dot code 201 (Step S 205). In the case of the dot code shown in FIG. 10, the data type shows “size: 100×200 pixels, color: 8 bits and data format: image data in the BMP format”.

Upon receiving the data type (Step S304), the external device judges if it can utilize data of the data type notified by the code reading apparatus 100 or not and notifies the code reading apparatus 100 of its judgment (Step S305). If the code reading apparatus 100 is connected to a mobile telephone set 400 as shown in FIG. 1 and the mobile telephone set 400 can use image data for displaying standby images, the mobile telephone set 400 notifies the code reading apparatus 100 of the fact that it can utilize data of the data type.

Upon receiving the notification from the external device, the code reading apparatus 100 determines if the external device can utilize the data in the transmission data section 214 of the restored data or not (Step S206). Then, the code reading apparatus 100 proceeds to Step S203 for transmitting the data only when it is determined that the external device can utilize the data in the transmission data section 214. If, on the other hand, it is determined in Step S206 that the external device cannot utilize the data in the transmission data section 214 of the restored data, it means that the code reading apparatus 100 has succeeded in recognizing the external device and can exchange data with the latter but the data in the transmission data section 214 of the restored data is of the type that the external device cannot utilize (e.g., the external device is not adapted to the compression format of the image data). Then, the code reading apparatus 100 proceeds to Step S204 and hence does not transmit any data.

As the third embodiment determines if the external device can utilize the data in the transmission data section 214 of the dot code 201 or not and transmits the data only when it determines that the external device can utilize it, it is prevented from transmitting useless data.

[4th Embodiment]

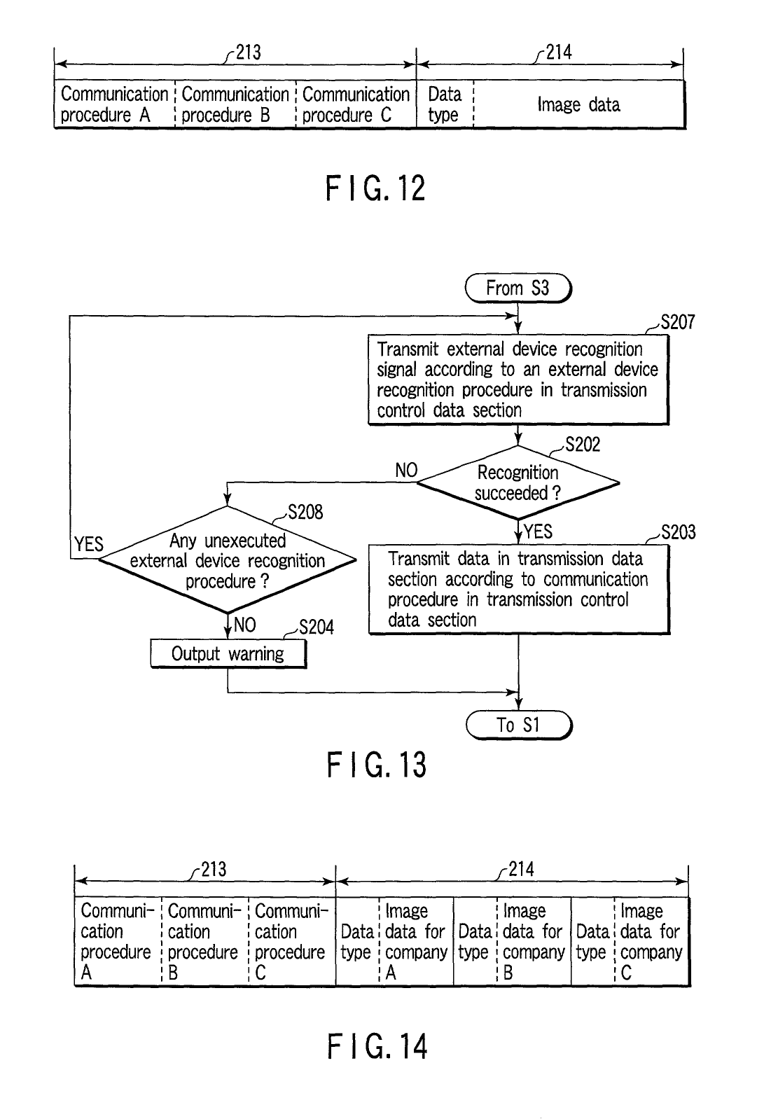

It is also possible to store communication procedures to be followed for communicating with a plurality of external devices in the transmission control data section 213 of the restored data as shown in FIG. 12. For example, the transmission control data section 213 may store the communication procedure A to be followed when communicating with a mobile telephone set available from company A, the communication procedure B to be followed when communicating with a mobile telephone set available from company B and the communication procedure C to be followed when communicating with a mobile telephone set available from company C. Each of the communication procedures may include the communication protocol to be observed for exchanging data between the code reading apparatus 100 and the external device such the procedure for recognizing an external device, the length of data to be transmitted/received, the error correction method and so on and application programs to be used for transmitting/receiving data by using the communication protocol.

FIG. 13 is a flow chart of the operation of the fourth embodiment of code reading apparatus 100 of the invention that takes place when it reads the dot code 201 representing the data to be restored. Note that the processing operation from the acquisition of the restored data of the code reading apparatus 100 to the extraction and the storage in the memory of the data in the transmission control data section 213 and the transmission data section 214 and the one to be conducted when the restored data are found to be sound data or image data are same as those from Step S1 through S3 and Step S5 in FIG. 6 respectively, although they are not shown in the flow chart of FIG. 13.

Referring to FIG. 13, the data processing section 115 selects one of the communication procedures stored in the communication control data section 213 extracted from the restored data (e.g., “communication procedure A” in FIG. 12) and transmits a signal for recognizing an external device to the external device according to the procedure for recognizing an external device (Step S207).

If the code reading apparatus 100 succeeds in recognizing the external device and it is determined that the external device can receive data according to the communication procedure (Step S202), the code reading apparatus 100 transmits the data in the transmission data section 214, following the selected communication procedure.

If, on the other hand, there is no response from the external device or, if there is a response, it is determined that the external device is not adapted to follow the communication procedure because the response signal is not in the predetermined format, the code reading apparatus 100 checks if the communication control data section 213 stores any other communication procedure that has not been used yet (Step S208). If the communication control data section 213 stores such a communication procedure, the code reading apparatus 100 returns to Step S207, where it transmits a signal for recognizing an external device according to the procedure for recognizing an external device that is shown in the communication procedure.

When all the communication procedures are tried and found to be not effective (Step S208), the code reading apparatus 100 so judges that the connected external device is not adapted to the restored data or no external device is connected to it and issues a warning (Step S204). Then, it terminates the operation without transmitting the data in the transmission data section 214.

Assume here that the code reading apparatus 100 is connected to a mobile telephone set manufactured by company B and adapted to receive standby images and reads a dot code 201 as shown in FIG. 12. Then, the code reading apparatus 100 firstly try to recognize the external device according to the communication procedure A for a mobile telephone set manufactured by company A. The code reading apparatus 100 will fail in recognizing the external device because a mobile telephone set manufactured by company B is connected thereto. Then, it tries to recognize the external device according to the communication procedure B for a mobile telephone set manufactured by company B. This time, it will succeed in recognizing the external device. Then, the code reading apparatus 100 determines that the mobile telephone set from company B is adapted to receive the data and transmits the data stored in the transmission data section 214 according to the selected communication procedure B. With the above described arrangement, the code reading apparatus 100 can select an appropriate one of the plurality of communication procedures stored in the transmission control data section 213 and transmit the data to the mobile telephone set connected to it, following the right procedure.

As described above, with this arrangement that the transmission control data section 213 of the restored data stores a plurality of communication procedures for a plurality of devices and the code reading apparatus 100 tries to recognize the external device according to the plurality of communication procedures on a one by one basis so that the code reading apparatus 100 proceeds to the subsequent operation for transmitting data only when the external device is adapted to one of the communication procedures. Thus, a single dot code 201 can adapt itself to a plurality of devices and hence the user does not need to select a dot code 201 adapted to his or her own device to a great advantage of the user. Additionally, the space required for printing dot codes can be minimized since a single dot code 201 can be used with a plurality of external devices.

It may alternatively be so arranged that the code reading apparatus 100 transmits the data in the transmission data section 214 after succeeding in recognizing the external device by following the procedures shown in Steps S205 and S206 in the flow chart of FIG. 11 and determining if the external device is adapted to use the data on the basis of the detected data type indicating the type and the format of the data stored in the transmission data section 214.

While the transmission data section 214 of the dot code stores a single data that can be commonly used for mobile telephone sets available from the manufacturing companies in the above description, as is shown on FIG. 14, it may alternatively be so arranged that the transmission data section 214 stores a plurality of data that can respectively be used for mobile telephone sets available from the manufacturing companies so that the right data may be transmitted to a corresponding mobile telephone set according to the corresponding communication procedure.

[5th Embodiment]

Now, a fifth embodiment of the invention will be described below.

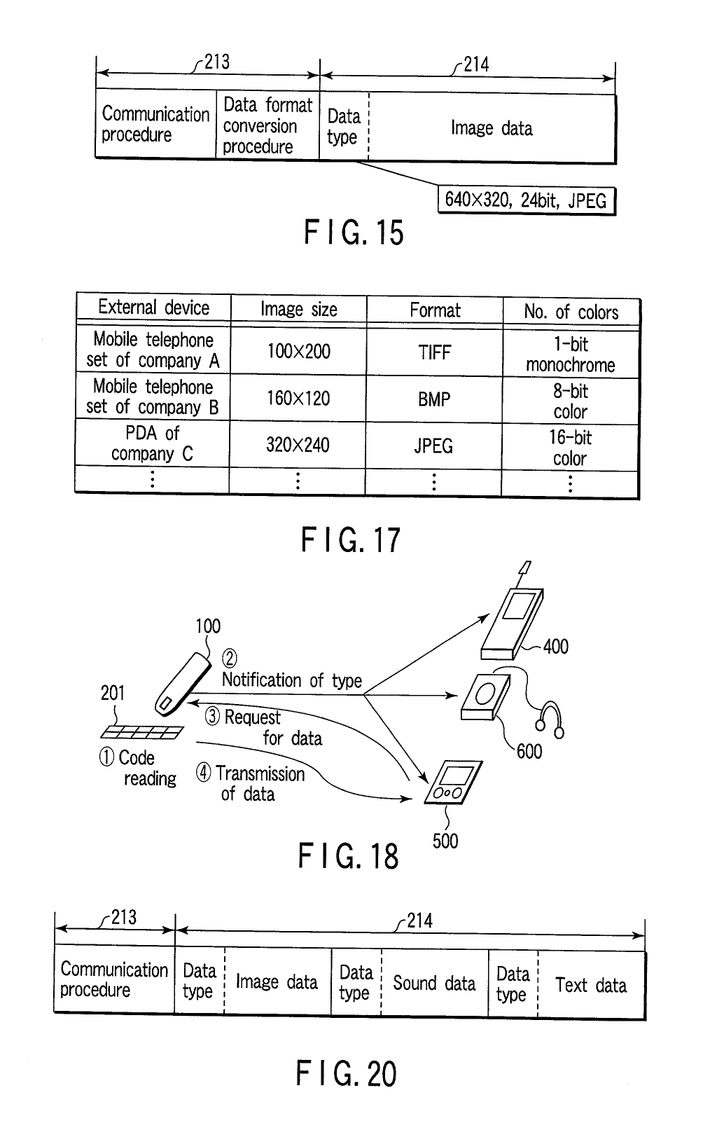

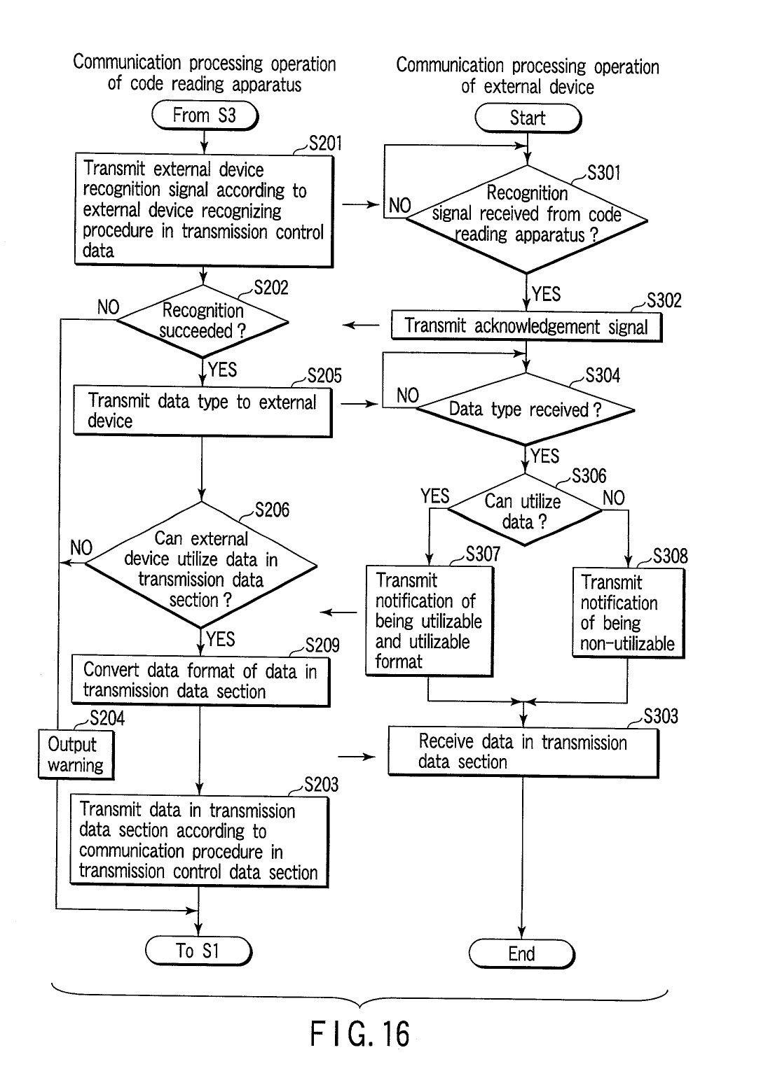

This embodiment of code reading apparatus 100 is adapted transmit data to an external device connected to it after recognizing the external device and, if necessary, converting the format of the data in the transmission data section 214 to the one adapted to the external device. This operation will be described by referring to FIGS. 15 and 16.

FIG. 15 is a schematic illustration of the logical structure of the data section of a data that can be read from a dot code by this fifth embodiment of code reading apparatus. The transmission control data section 213 stores communication procedures to be followed by the code reading apparatus 100 for exchanging information with the external device and additionally data format conversion procedures to be followed for processing the data in the transmission data section 214 in such a way that the data becomes adapted to the external device connected to the code reading apparatus 100. The data format conversion procedures may include the one for converting the size of the image data, the one for reducing the number of colors and the one for converting the compression method.

Now, the operation of the code reading apparatus 100 for scanning the dot code 201 storing image data as shown in FIG. 15 will be described by referring to the flow chart of FIG. 16. Note that the processing operation from the acquisition of the restored data of the code reading apparatus 100 to the extraction and the storage in the memory of the data in the transmission control data section 213 and the transmission data section 214 and the one to be conducted when the restored data are found to be sound data or image data are same as those from Step S1 through S3 and Step S5 in FIG. 6 respectively, although they are not shown in the flow chart of FIG. 16. Additionally, some of the steps indicated by the reference numbers same as those of the flow chart of FIG. 9 will not be described.

Referring to FIG. 16, if the code reading apparatus 100 succeeds in recognizing the external device (Step S202), it notifies the external device of the data type of the data to be transmitted on the basis of the data type of the transmission data section 214 of the restored and acquired data (Step S205).

Upon receiving the data type (Step S304), the external device determines if it can utilize the data of the notified data type or not (Step S306) and, if it is determined that it cannot utilize the data of the notified data type, it transmits a notification that it cannot utilize the data (Step S308). If, on the other hand, it is determined that the external device can utilize the data, it notifies the code reading apparatus 100 of the utilizable format storing the information on the data type including the size, the format (JPEG, GIF, BMP, TIFF, etc.) and the number of colors of the image it can use in addition to the notification that it can utilize the data (Step S 307).

Upon receiving the notification from the external device on the utilizable format, the code reading apparatus 100 determines if the data stored in the transmission data section 214 of the restored data can be utilized by the external device or not (Step S206). If it is determined that the external device cannot utilize the data because it has notified the code reading apparatus 100 of the fact that it does not have any image display means and hence cannot utilize the data in the transmission data section 214, the code reading apparatus 100 issues a warning to the user, telling the fact (Step S204), and terminates the operation without transmitting the data.

In, on the other hand, it is determined that the external device can utilize the data stored in the transmission data section 214 of the restored data, the notification of the external device contains information on the format of data it can utilize. Therefore, the data processing section 115 converts the data format of the data stored in the transmission data section 214 into the one that the external device can utilize according to the above information and the data format converting procedure stored in the transmission control data section 213 of the restored data (Step S209).

Since the notification on the utilizable format contains information on the data type including the size, the format and the number of colors of the image it can use, the code reading apparatus 100 converts the image data (image size: 640×480, 24 bits, JPEG) stored in the transmission data section 214 into the data format that the external device can utilize on the basis of the information.

Then, the code reading apparatus 100 transmits the converted data to the external device, following the communication protocol stored in the transmission control data section 213 (Step S203).

While the external device itself notifies the code reading apparatus 100 of the data format it can utilize in the above description, it may alternatively be so arranged that the encoded data contains a table showing the external devices and corresponding data formats as shown in FIG. 17. Then, the code reading apparatus 100 can determine the data format that the external device connected to it can utilize by referring to the table when it recognizes the external device.

Thus, the fifth embodiment of code reading apparatus 100 is adapted to recognize the external device connected to it, converts the data format of the data in the transmission data section 214 to the one that the external device can utilize and then transmits the data to the external device. Therefore, the format of the data to be transmitted does not need to be converted in advance to the one that the external device can utilize. This means that a single dot code can be transmitted to a plurality of external devices adapted to utilize respective data formats that are different from each other and it is not necessary to provide different dot codes in advance for the respective external devices so that the space for printing dot codes 201 can be minimized.

[6th Embodiment]

Now, a sixth embodiment of code reading apparatus according to the invention will be described. This embodiment is adapted to transmit data to a plurality of unspecified devices having an I/F with which the code reading apparatus 100 can be connected to them as shown in FIG. 18. In FIG. 18, the mobile telephone set 400, the PDA (personal digital assistance) 500 and the silicon audio 600 that may be an MP3 (MPEG-1 Audio Layer 3) player have a common external I/F and can exchange data with the code reading apparatus 100.

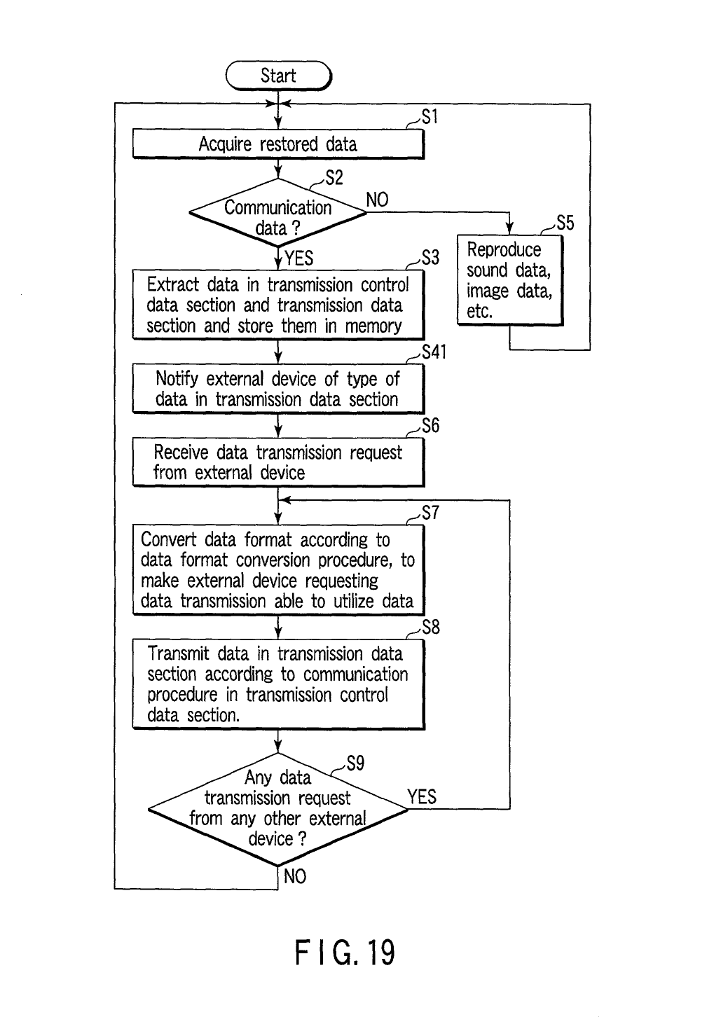

Firstly, the operation of the code reading apparatus 100 when it scans the dot code 201 storing image data as shown in FIG. 15 in the above described environment will be described by referring to the flow chart of FIG. 19. Note that the processing operation of the code reading apparatus 100 from acquiring restored data to extracting data from the transmission control data section 213 and the transmission data section 214 and storing them in the memory (Steps S1 through S3) and the processing operation to be carried out by the code reading apparatus 100 when the restored data is a sound data or an image data (Step S5) are respectively similar to those from Step S1 through Step S3 and Step S5 in FIG. 6.

Thus, this embodiment of code reading apparatus 100 stores the data in the memory in Step S3 and then notifies the external devices of the type of data (sound, voice, image, text, URL, etc.) in the transmission data section 214 by way of the external I/F 116 according to the information on the type of the data stored in the transmission data section 214 of the restored and acquired data (Step S41).

Upon receiving the notification telling the data type from the code reading apparatus 100, each of the external devices including the mobile telephone set 400, the PDA 500 and the silicon audio 600 determines if it can utilize (or needs) the data type and sends a data transmission request to the code reading apparatus 100 if it can utilize the data type. Since the mobile telephone set 400 and the PDA are provided with an image display means and hence can utilize image data, they sends a data transmission request to the code reading apparatus 100. The data transmission request indicates that the external device can utilize the data that the code reading apparatus 100 has acquired and contains information on the data format that the external device can utilize. The data format may typically include the image size, the image format (JPEG, GIF, BMP, TIFF, etc.) and the number of colors it can use.

Thus, the code reading apparatus 100 receives the data transmission requests from each of the related external devices (Step S6). Then, it extracts the information on the data format that the external device can utilize from the data transmission request and converts the data format of the image data in the transmission data section 214 to the one contained in the data transmission request and adapted to the external device (Step S7). The data is converted by following the data format conversion procedure stored in the transmission control data section 213 of the restored data.

Subsequently, the code reading apparatus 100 transmits the converted data to the external device according to the communication procedure stored in the transmission control data section 213 (Step S8). When the transmission is completed, the code reading apparatus 100 checks if there is any other data transmission request from some other external device (Step S9) and repeats the processing operation from Step S7 to Step S9 for data transmission until there is no data request is found.

Thus, the above described sixth embodiment of code reading apparatus is adapted to transmit data in the data formats that external devices can utilize respectively in response to the respective requests for the data without providing different dot codes in advance for the respective external devices.

While the data of the transmission data section 214 is described above in terms of image data or call chime data, the transmission data section 214 can alternatively store a sound data, a text data, a URL or a digital data to be used for selecting a functional feature of the external device.

It is also possible to make the transmission data section 214 store various different digital data. Then, as shown in FIG. 20, all the related external devices may receive all the data stored in the transmission data section 214 or, alternatively, each of the related external devices may receive only the data of the type it can utilize.

While external devices to be connected to a code reading apparatus 100 are described above in terms of mobile telephone set 400, PDA 500 and so on, the present invention is not limited thereto and any other electronic device such as a video recorder or a personal computer having an external I/F may be effectively used with a code reading apparatus 100 according to the invention.

While the present invention is described above by way of preferred embodiments, the present invention is by no means limited to them, which can be modified in various different ways without departing from the scope of the invention.

For example, codes that can be used with a code reading apparatus according to the invention are not limited to dot codes as shown in FIG. 2 and the present invention can be used for any optically readable codes.

Now, the present invention will be summarily described below.

(1) A code reading apparatus comprising:

means for optically reading a code representing a data and for restoring the data, the code being recorded on a recording medium and being optically readable by manual scanning; and

data transmitting means for transmitting transmission data to some other electronic device according to transmission control data, when the data includes the transmission data to be transmitted from the code reading apparatus to the other electronic device and utilized by the other electronic device and the transmission control data required for transmitting the transmission data from the code reading apparatus to the other electronic device.

Thus, the code reading apparatus does not need to know in advance the communication procedure that it should follow for the communication between the code reading apparatus and the external device. Additionally, the code reading apparatus can be connected to any of a number of external devices simply by modifying the communication procedure. Still additionally, it is no longer necessary for the user to select one or more than one functional features of the code reading apparatus to make it adapted to the external device to be connected to it. Then, the user is relieved of making errors.

(2) The code reading apparatus according to (1), wherein

the data transmitting means includes a judging means for judging if the other electronic device is adapted to receive the transmission data transmitted to it or not on the basis of the transmission control data before transmitting the transmission data to the other electronic device.

Thus, the code reading apparatus transmits the data to the external device only when the latter is judged to be adapted to communicate with it for receiving the data on the basis of the transmission control data of the code. Therefore, any operation error of transmitting data to an external device that is not adapted to the code can be effectively avoided.

(3) The code reading apparatus according to (2), wherein

the data transmitting means further includes a confirming means for confirming that the other electronic device can utilize the transmission data on the basis of the transmission control data before transmitting the transmission data to the other electronic device.

Thus, the transmitting means transmits the data only to an external device that can communicate with the code reading apparatus and utilize the data. Therefore, no useless data will be sent to the external device.

(4) The code reading apparatus according to (1), wherein

when the transmission control data include a plurality of different transmission control data necessary for transmitting the transmission data to a plurality of other different electronic devices, the transmitting means includes judging means for judging if the other electronic device can receive the transmission data, using sequentially the different transmission control data before transmitting the transmission data to the other electronic device.

Thus, it is no longer necessary to provide different codes for different communication procedures and a single code can be made to be adapted to a plurality of different devices. Therefore, the space required for printing codes can be minimized and the user is not required to select a code that is adapted to the external device that the user connect to the code reading apparatus to a great convenience on the part of the user.

(5) The code reading apparatus according to (4), wherein

the data transmitting means further includes confirming means for confirming that the other electronic device can utilize the transmission data by sequentially using the transmission control data on a one by one basis before transmitting the transmission data to the other electronic device.

Thus, the code reading apparatus transmits the data only to the external device that can utilize the data after the confirming operation. Therefore, no useless data will be sent to the external device.

(6) The code reading apparatus according to one of (1), (2) and (4), wherein

the data transmitting means further includes data format converting means for converting the format of the transmission data, allowing the other electronic device to utilize the transmission data before transmitting the transmission data to the electronic device.

Thus, the code reading apparatus transmits the transmission data after converting the format of the data to the one adapted to the external device to which the code reading apparatus is connected. Therefore, the code does not need to contain the transmission data adapted to all the external devices that may be connected to the code reading apparatus. Then, the space required for printing codes can be minimized.

(7) The code reading apparatus according to one of (1), (2) and (4), wherein

when the transmission data includes a plurality of different transmission data, the data transmitting means includes confirming means for confirming the one that the other electronic device can utilize by checking the plurality of transmission data on a one by one basis before transmitting the transmission data.

Thus, a single code can be made to contain a plurality of different transmission data to minimize the space required for printing codes. Additionally, only the transmission data that the external device can utilize can be selectively transmitted to the device out of a plurality of transmission data.

(8) The code reading apparatus according to (1), wherein

the data transmitting means includes notifying means for simultaneously notifying a plurality of unspecified electronic devices with the type of the transmission data and transmits the transmission data to one or more than one of the plurality of unspecified electronic devices received the transmission data in response to the data transmission requests from the electronic devices requiring the transmission data according to the transmission control data.

Thus, the code reading apparatus can simultaneously transmit the transmission data to a plurality of unspecified electronic devices that requires the data.

(9) A recording medium storing a recorded code representing data and adapted to be optically read by manual scanning, the data comprising:

transmission data to be transmitted from a code reading apparatus adapted to read the code to some other electronic device and utilized by the other electric device; and

transmission control data necessary for transmitting the transmission data from the code reading apparatus to the other electronic device.

Thus, the code reading apparatus does not need to know in advance the communication procedure that it should follow for the communication between the code reading apparatus and the external device.

(10) The recording medium according to (9), wherein

the transmission control data includes judgment data necessary for judging if the other electronic device can receive the transmission data or not before the code reading apparatus transmits the transmission data to the other electronic device.

Thus, the code reading apparatus can judge if it can communicate with the external device or not.

(11) The recording medium according to (10), wherein

the transmission control data further includes confirmation data for confirming that the other electronic device can utilize the transmission data before transmitting the transmission data to the other electronic device.

Thus, the code reading apparatus can judge if it can communicate with the external device or not.

(12) The recording medium according to (9), wherein

the transmission control data includes a plurality of different transmission control data necessary for transmitting the transmission data to a plurality of other different electronic devices.

Thus, the code reading apparatus can communicate with a plurality of external devices, using a single code.

Additionally, the space required for printing codes is minimized.

(13) The recording medium according to (12), wherein

each of the plurality of different transmission control data includes:

judgment data necessary for judging if the other electronic device can receive the transmission data or not before the code reading apparatus transmits the transmission data to the other electronic device; and

confirmation data for confirming that the other electronic device can utilize the transmission data.

Thus, the code reading apparatus can communicate with a plurality of external devices, using a single code and judge if the external device can utilize the transmission data.

(14) The recording medium according to (9), wherein

the transmission data includes a plurality of different transmission data to be utilized by the other electronic device.

Thus, a plurality of transmission data can be transmitted by scanning a single code.

(15) The recording medium according to (9), wherein

the transmission control data includes data format converting data necessary for converting the format of the transmission data to the one that the other electronic device can utilize.

Thus, the code reading apparatus can converts the data format to make it adapted to the external device to which it is connected.

(16) An electronic device adapted to receive data transmitted from a code reading apparatus which optically reads a code representing the data and recorded on a recording medium by manual scanning and restores the data and to utilize the data, the electronic device comprising:

data receiving means for receiving transmission data transmitted from the code reading apparatus according to transmission control data, when the data restored by the code reading apparatus includes the transmission data to be transmitted from the code reading apparatus to the electronic device and utilized by the electronic device and the transmission control data required for transmitting the transmission data from the code reading apparatus to the electronic device; and

data utilizing means for utilizing the transmission data received by the data receiving means.

Thus, the electronic device can be connected to a code reading apparatus and receive the transmission data contained in a code.

(17) The electronic device according to (16), wherein

the data receiving means includes judging means for judging if the electronic device can receive the transmission data transmitted from the code reading apparatus or not according to the transmission control data.

Thus, the electronic device can be connected to a code reading apparatus and receive the data that is contained in the code and the device can receive.

(18) The electronic device according to (17), wherein

the data receiving means further includes confirming means for confirming that the electronic device can utilize the transmission data transmitted from the code reading apparatus according to the transmission control data.

Thus, the electronic device can be connected to a code reading apparatus and receive the data that is contained in the code and the device can utilize.

(19) A data transmission/reception system comprising:

a code reading apparatus adapted to optically read a code representing a data and recorded on a recording medium optically readable by manual scanning and restore the data; and

an electronic device adapted to receive and utilize the data transmitted from the code reading apparatus, wherein

the code reading apparatus includes data transmitting means for transmitting transmission data to the electronic device according to transmission control data, when the data includes the transmission data to be transmitted from the code reading apparatus to the electronic device and utilized by the electronic device and the transmission control data required for transmitting the transmission data from the code reading apparatus to the electronic device, and

the electronic device includes data receiving means for receiving the transmission data transmitted from the code reading apparatus according to the transmission control data.

Thus, the code reading apparatus can transmit the transmission data according to the transmission control data contained in the code, following an appropriate procedure, without known the component procedure to be followed by the code reading apparatus and the external device connected to the code reading apparatus.

Therefore, if the external device connected to the code reading apparatus is switched, the code reading apparatus and the external device can exchange data without modifying the code reading apparatus by simply providing a code containing the right connection procedure for the external device.

(20) A data transmission/reception method to be used by a code reading apparatus adapted to optically read a code representing a data and recorded on a recording medium optically readable by manual scanning and restore the data and an electronic device adapted to receive and utilize the data transmitted from the code reading apparatus, comprising:

transmitting transmission data to the other electronic device from the code reading apparatus according to transmission control data, when the data includes the transmission data to be transmitted from the code reading apparatus to the electronic device and utilized by the other electronic device and the transmission control data required for transmitting the transmission data from the code reading apparatus to the other electronic device; and

receiving at the electronic device the transmission data transmitted from the code reading apparatus according to the transmission control data.

Thus, the code reading apparatus can transmit the transmission data according to the transmission control data contained in the code, following an appropriate procedure, without known the component procedure to be followed by the code reading apparatus and the external device connected to the code reading apparatus.

Therefore, if the external device connected to the code reading apparatus is switched, the code reading apparatus and the external device can exchange data without modifying the code reading apparatus by simply providing a code containing the right connection procedure for the external device.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A code reading apparatus comprising:
means for optically reading a code representing a data and for restoring said data, said code being recorded on a recording medium and being optically readable by manual scanning; and
data transmitting means for transmitting transmission data to some other electronic device according to transmission control data, when said data includes said transmission data to be transmitted from said code reading apparatus to said other electronic device and utilized by said other electronic device and said transmission control data required for transmitting said transmission data from said code reading apparatus to said other electronic device.

2. The code reading apparatus according to claim 1, wherein
said data transmitting means includes a judging means for judging if said other electronic device is adapted to receive the transmission data transmitted to it or not on the basis of said transmission control data before transmitting said transmission data to said other electronic device.

3. The code reading apparatus according to claim 2, wherein
said data transmitting means further includes a confirming means for confirming that said other electronic device can utilize the transmission data on the basis of said transmission control data before transmitting the transmission data to said other electronic device.

4. The code reading apparatus according to claim 2, wherein
said data transmitting means further includes data format converting means for converting the format of the transmission data, allowing said other electronic device to utilize the transmission data before transmitting said transmission data to said electronic device.

5. The code reading apparatus according to claim 2, wherein
when said transmission data includes a plurality of different transmission data, said data transmitting means includes confirming means for confirming the one that said other electronic device can utilize by checking said plurality of transmission data on a one by one basis before transmitting said transmission data.

6. The code reading apparatus according to claim 1, wherein
when said transmission control data include a plurality of different transmission control data necessary for transmitting said transmission data to a plurality of other different electronic devices, said transmitting means includes judging means for judging if said other electronic device can receive said transmission data, using sequentially said different transmission control data before transmitting said transmission data to said other electronic device.

7. The code reading apparatus according to claim 6, wherein
said data transmitting means further includes confirming means for confirming that said other electronic device can utilize the transmission data by sequentially using said transmission control data on a one by one basis before transmitting the transmission data to said other electronic device.

8. The code reading apparatus according to claim 6, wherein
said data transmitting means further includes data format converting means for converting the format of the transmission data, allowing said other electronic device to utilize the transmission data before transmitting said transmission data to said electronic device.

9. The code reading apparatus according to claim 6, wherein
when said transmission data includes a plurality of different transmission data, said data transmitting means includes confirming means for confirming the one that said other electronic device can utilize by checking said plurality of transmission data on a one by one basis before transmitting said transmission data.

10. The code reading apparatus according to claim 1, wherein
said data transmitting means further includes data format converting means for converting the format of the transmission data, allowing said other electronic device to utilize the transmission data before transmitting said transmission data to said electronic device.

11. The code reading apparatus according to claim 1, wherein
when said transmission data includes a plurality of different transmission data, said data transmitting means includes confirming means for confirming the one that said other electronic device can utilize by checking said plurality of transmission data on a one by one basis before transmitting said transmission data.

12. The code reading apparatus according to claim 1, wherein
said data transmitting means includes notifying means for simultaneously notifying a plurality of unspecified electronic devices with the type of the transmission data and transmits said transmission data to one or more than one of said plurality of unspecified electronic devices received said transmission data in response to the data transmission requests from said electronic devices requiring said transmission data according to the transmission control data.

13. A recording medium storing a recorded code representing data and adapted to be optically read by manual scanning, said data comprising:
transmission data to be transmitted from a code reading apparatus adapted to read said code to some other electronic device and utilized by said other electric device; and
transmission control data necessary for transmitting said transmission data from said code reading apparatus to said other electronic device.

14. The recording medium according to claim 13, wherein
said transmission control data includes judgment data necessary for judging if said other electronic device can receive the transmission data or not before said code reading apparatus transmits said transmission data to said other electronic device.

15. The recording medium according to claim 14, wherein
said transmission control data further includes confirmation data for confirming that said other electronic device can utilize the transmission data before transmitting the transmission data to said other electronic device.

16. The recording medium according to claim 13, wherein
said transmission control data includes a plurality of different transmission control data necessary for transmitting said transmission data to a plurality of other different electronic devices.

17. The recording medium according to claim 16, wherein
each of said plurality of different transmission control data includes:
judgment data necessary for judging if the other electronic device can receive the transmission data or not before said code reading apparatus transmits said transmission data to said other electronic device; and
confirmation data for confirming that said other electronic device can utilize the transmission data.

18. The recording medium according to claim 13, wherein
said transmission data includes a plurality of different transmission data to be utilized by said other electronic device.

19. The recording medium according to claim 13, wherein
said transmission control data includes data format converting data necessary for converting the format of said transmission data to the one that said other electronic device can utilize.

20. An electronic device adapted to receive data transmitted from a code reading apparatus which optically reads a code representing said data and recorded on a recording medium by manual scanning and restores said data and to utilize said data, said electronic device comprising:
data receiving means for receiving transmission data transmitted from said code reading apparatus according to transmission control data, when said data restored by said code reading apparatus includes said transmission data to be transmitted from said code reading apparatus to said electronic device and utilized by said electronic device and said transmission control data required for transmitting said transmission data from said code reading apparatus to said electronic device; and
data utilizing means for utilizing said transmission data received by said data receiving means.

21. The electronic device according to claim 20, wherein
said data receiving means includes judging means for judging if the electronic device can receive the transmission data transmitted from said code reading apparatus or not according to said transmission control data.

22. The electronic device according to claim 21, wherein
said data receiving means further includes confirming means for confirming that the electronic device can utilize the transmission data transmitted from said code reading apparatus according to the transmission control data.

23. A data transmission/reception system comprising:
a code reading apparatus adapted to optically read a code representing a data and recorded on a recording medium optically readable by manual scanning and restore said data; and
an electronic device adapted to receive and utilize said data transmitted from said code reading apparatus, wherein
said code reading apparatus includes data transmitting means for transmitting transmission data to said electronic device according to transmission control data, when said data includes said transmission data to be transmitted from said code reading apparatus to said electronic device and utilized by said electronic device and said transmission control data required for transmitting said transmission data from said code reading apparatus to said electronic device, and
said electronic device includes data receiving means for receiving said transmission data transmitted from said code reading apparatus according to said transmission control data.

24. A data transmission/reception method to be used by a code reading apparatus adapted to optically read a code representing a data and recorded on a recording medium optically readable by manual scanning and restore said data and an electronic device adapted to receive and utilize said data transmitted from said code reading apparatus, comprising:
transmitting transmission data to said other electronic device from said code reading apparatus according to transmission control data, when said data includes said transmission data to be transmitted from said code reading apparatus to said electronic device and utilized by said other electronic device and said transmission control data required for transmitting said transmission data from said code reading apparatus to said other electronic device; and
receiving at said electronic device said transmission data transmitted from said code reading apparatus according to said transmission control data.
